(19) United States
(12) Patent Application Publication
(10) Pub. No.: US 2007/0019255 A1
(43) Pub. Date: Jan. 25, 2007

(54) Image input apparatus and image forming method

(75) Inventors: Jun Sakakibara, Tokyo (JP); Koji Tanimoto, Tagata-gun (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/187,826

(22) Filed: Jul. 25, 2005

(51) Int. Cl. H04N 1/46

(52) U.S. Cl. 358/505; 358/512

(57) ABSTRACT

A system control unit detects, prior to inputting an image of an original, color information of the original using 3-line image sensors, which are included in 4-line image sensors and have light receiving surfaces provided with color filters, determines whether the original is a monochromatic original or a color original, on the basis of the detected color information, inputs, when it is determined that the original is the monochromatic original, the image of the original using a 1-line image sensor, which is included in the 4-line image sensors and has a light receiving surface provided with no color filter, and inputs, when it is determined that the original is the color original, the image of the original using the 3-line image sensors, which are included in the 4-line image sensors and have the light receiving surfaces provided with the color filters.

### BACKGROUND OF THE INVENTION

1. Field of the Invention

The present invention relates to an image input apparatus, which is typified by a scanner that scans an original using a CCD sensor and reads image information, and an image input apparatus of a digital copier, and also relates to an image forming apparatus using the image input apparatus.

2. Description of the Related Art

Typical examples of conventional CCD line sensors, which are used in reducing optical systems, are a 1-line line sensor that is composed of a single line sensor, and a 3-line line sensor that is composed of three line sensors, on the surfaces of which color filters of red (hereinafter referred to as “R”), green (“G”) and blue (“B”) are disposed.

The 1-line line sensor is basically used for reading a monochromatic original. When a color original is read by the 1-line CCD sensor, the following scheme is adopted. That is, three light sources having spectral characteristics of R, G and B that are the three primary colors of light are provided. These light sources are successively turned on, and thereby image information on the color original is divided into R, G and B color information units, and these information units are read. In addition, there is another method in which a light source having spectral characteristics of white is used, and color filters of R, G and B are disposed on an optical path between this light source and the CCD sensor. By switching the color filters, color information that is input to the line sensor is separated.

The 3-line line sensor comprising the three line sensors is basically used for reading a color original. A light source, which is used in this case, has spectral characteristics that fully cover a visible light range of oscillation wavelengths of 400 nm to 700 nm. Color information of R, G and B is separated by color filters that are disposed on the surfaces of the respective line sensors.

When a monochromatic original is to be read by this 3-line CCD sensor, there are two methods. In one method, an output from one of the constituent three line sensors is used. In general, an output from the G line sensor is used in order to exactly read a red stamp. In the other method, all the outputs from the three line sensors are used to generate white/black information.

In the case where color information is read by the 1-line CCD sensor that comprises a single line sensor, the light sources are switched, or the color filters are switched, as described above. As a result, the control of the relationship between the light sources becomes complex, and the cost for the control increases.

In the case where monochromatic information is read by using an output from one of the three lines sensors that constitute the 3-line CCD sensor, if a line sensor with sensitivity to G is used, red information can be read, as mentioned above, but distinction between green color information and white information on the original cannot be made. As a result, there is such a problem that information of a green character or image cannot be read. Similarly, if a line sensor with sensitivity to R is used, red information cannot be read. If a line sensor with sensitivity to B is used, blue information cannot be read.

To cope with this problem, the following method is adopted. That is, white/black information is generated by using all outputs of the three line sensors of the 3-line CCD sensor, that is, on the basis of image information of R, G and B. However, in the 3-line line sensor, the three line sensors are physically spaced apart, and consequently there is a problem that the respective line sensors cannot read information at the same location on the original. In order to correct misregistration in position information, it is necessary to execute line-by-line correction using a line buffer.

At the time of reading, exact registration is possible by using the line buffer, if the inter-line distance of the three line sensors has a proportional relationship to an integer-number of times of a 1-line reading range in the sub-scan direction on the original. However, depending on the magnification of reading, the 1-line reading range in the sub-scan direction varies, and the proportional relationship is not established.

In this case, such a problem arises that registration of color information cannot satisfactorily be made by the line buffer. For example, in the case of an image of a monochromatic character, which sharply changes from white to black, or from black to white, such a problem arises that a pseudo-color, such as red or blue, occurs at the point of change.

In the meantime, in the case where pre-scan is executed to detect color information of an original, two scan operations, i.e. pre-scan and regular scan, are performed. As a result, such a problem arises that the processing time increases.

### BRIEF SUMMARY OF THE INVENTION

The object of an aspect of the present invention is to provide an image input apparatus and an image forming apparatus, which can decrease the time from pre-scan to regular scan.

According to an aspect of the present invention, there is provided an image input apparatus that inputs an image of an original using 4-line image sensors, comprising: a control unit that executes, prior to inputting the image of the original, a control to detect color information of the original using 3-line image sensors, which are included in the 4-line image sensors and have light receiving surfaces provided with color filters; a determination unit that determines whether the original is a monochromatic original or a color original, on the basis of the color information detected by the control of the control unit; a first image input unit that inputs, when the determination unit determines that the original is the monochromatic original, the image of the original using a 1-line image sensor, which is included in the 4-line image sensors and has a light receiving surface provided with no color filter; and a second image input unit that inputs, when the determination unit determines that the original is the color original, the image of the original using the 3-line image sensors, which are included in the 4-line image sensors and have the light receiving surfaces provided with the color filters.

According to another aspect of the present invention, there is provided an image forming apparatus including an image input apparatus that inputs an image of an original using 4-line image sensors, the image forming apparatus comprising: a control unit that detects, prior to inputting the image of the original, color information of the original using 3-line image sensors, which are included in the 4-line image sensors and have light receiving surfaces provided with color filters; determines whether the original is a monochromatic original or a color original, on the basis of the detected color information; inputs, when it is determined that the original is the monochromatic original, the image of the original using a 1-line image sensor, which is included in the 4-line image sensors and has a light receiving surface provided with no color filter; and inputs, when it is determined that the original is the color original, the image of the original using the 3-line image sensors, which are included in the 4-line image sensors and have the light receiving surfaces provided with the color filters; and an image forming unit that forms an image on the basis of image information of the original that is input by the control of the control unit.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of an aspect of the invention.

FIG. 1 is a block diagram that schematically shows the structure of a copying apparatus comprising an image input apparatus and an image forming apparatus according to the present invention;

FIG. 2 schematically shows the structure of a 4-line CCD sensor that is used in the image input apparatus;

FIG. 3 schematically shows the structure of an original scan section that uses a 4-line CCD sensor in the image input apparatus;

FIG. 4 is a view for explaining a carriage operation;

FIG. 5 is a view for explaining the carriage operation;

FIG. 6 is a flow chart illustrating the carriage operation;

FIG. 7 is a view illustrating a concept of color information detection on an original;

FIG. 8 is a view illustrating a concept of color information detection on an original;

FIG. 9 is a view illustrating a concept of color information detection on an original;

FIG. 10 is a view for explaining color information detection on a single-color original;

FIG. 11 is a view for explaining color information detection on a single-color original;

FIG. 12 is a view for explaining color information detection on a single-color original;

FIG. 13 is a view for explaining color information detection on a color original;

FIG. 14 is a view for explaining color information detection on a color original;

FIG. 15 is a view for explaining color information detection on a color original;

FIG. 16 is a view for explaining a carriage operation;

FIG. 17 is a view for explaining the carriage operation;

FIG. 18 is a view for explaining the carriage operation;

FIG. 19 is a view for explaining the carriage operation;

FIG. 20 is a view for explaining the carriage operation;

FIG. 21 is a view for explaining the carriage operation;

FIG. 22 is a view for explaining the carriage operation;

FIG. 23 is a view for explaining the carriage operation;

FIG. 24 is a view for explaining the carriage operation;

FIG. 25 is a view for explaining the carriage operation;

FIG. 26 is a view for explaining coloring at a time of color registration of R, G and B; and

FIG. 27 is a view for explaining correction of an unnecessary color by an edge signal.

### DETAILED DESCRIPTION OF THE INVENTION

Embodiments of the present invention will now be described with reference to the accompanying drawings.

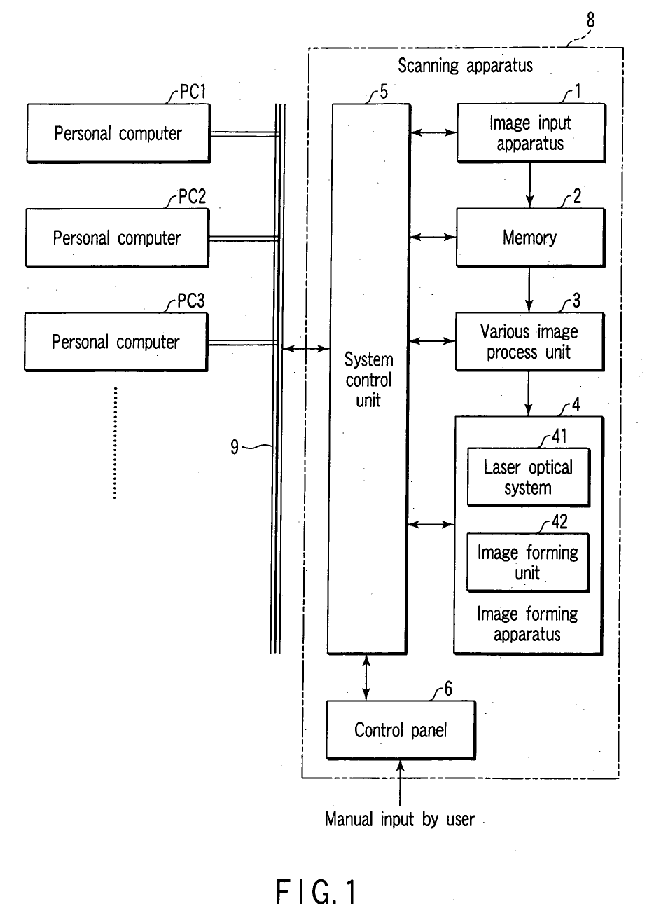

FIG. 1 schematically shows the structure of a copying apparatus comprising an image input apparatus and an image forming apparatus according to the present invention. The copying apparatus 8 comprises an image input apparatus 1, a memory 2, an image processing unit 3, an image forming apparatus 4, a system control unit 5 that executes an overall control, and a control panel 6.

The image input apparatus 1 scans an original using a 4-line CCD sensor (4-line image sensor), thereby reading image information, as will be described later in detail.

The memory 2 is a recording medium for storing image information, etc.

The image processing unit 3 executes various image processes for image information.

The image forming apparatus 4 comprises a laser optical system 41 using a semiconductor laser, and an image forming unit 42 that forms an image with toner using an electrophotographic process.

The control panel 6 is used for direct input by the user.

As will be described later in detail, personal computers PC1, PC2 and PC3 are connected to the copying apparatus 8 over a network 9.

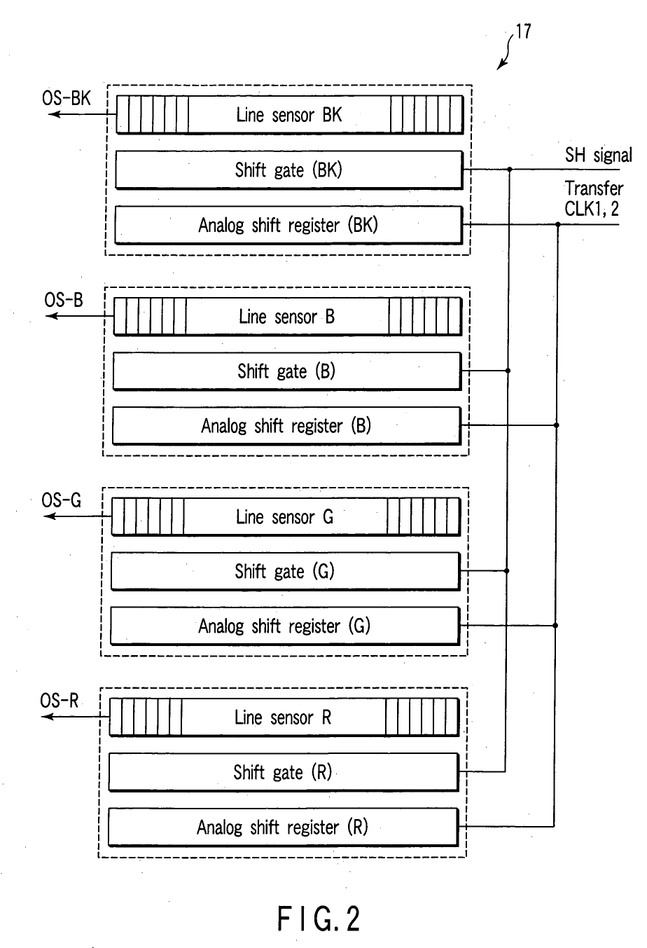

FIG. 2 schematically shows the structure of a 4-line CCD sensor 17 that is used in the image input apparatus 1. The 4-line CCD line sensor comprises a line sensor BK, which is a 1-line line sensor without a color filter; a line sensor B, which is a 1-line line sensor with a color filter of blue (hereinafter referred to as “B”) disposed on its surface; a line sensor G, which is a 1-line line sensor with a color filter of green (“G”) disposed on its surface; and a line sensor R, which is a 1-line line sensor with a color filter of red (“R”) disposed on its surface.

The 4-line CCD sensor 17 includes a shift gate (BK) and an analog shift register (BK) in association with the line sensor BK; a shift gate (B) and an analog shift register (B) in association with the line sensor B; a shift gate (G) and an analog shift register (G) in association with the line sensor G; and a shift gate (R) and an analog shift register (R) in association with the line sensor R.

The 4-line CCD sensor 17, as described above, comprises the line sensor BK with no color filter on its light receiving surface, and the line sensors R, G and B with color filters. In a case where light from a light source (not shown) is uniformly radiated on these line sensors, the line sensor R, line sensor G and line sensor B have sensitivity to only wavelengths of specific ranges, since they have the color filters. On the other hand, the line sensor BK has sensitivity to a wavelength range between less than 400 nm and more than 1000 nm. Thus, the amplitude of an analog signal that is output from the line sensor BK is greater than that of an analog signal that is output from each of the line sensors R, G and B.

The respective line sensors included in the 4-line CCD sensor 17 have the same pixel size. However, the pixel size of the line sensor BK may be made smaller than the pixel size of each of the line sensors R, G and B. For example, the pixel size of the line sensor BK may be set at ½ of the pixel size of each of the line sensors R, G and B.

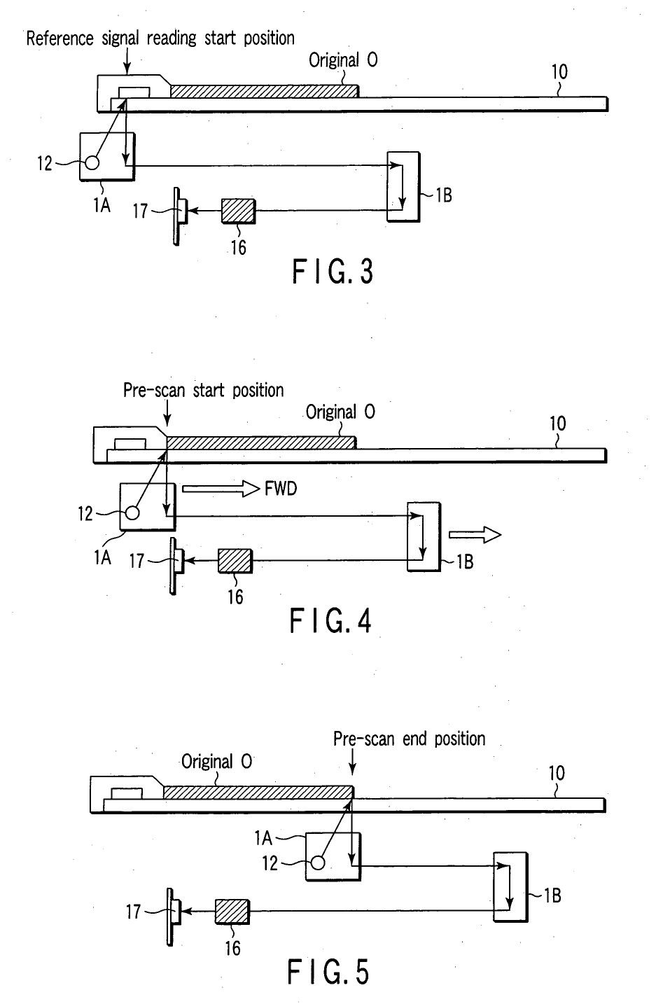

FIG. 3 schematically shows the structure of an original scan section that uses the 4-line CCD sensor in the image input apparatus 1. A first carriage 1A is moved to the right (FWD) in FIG. 3 from a reference signal reading start position, relative to an original O that is placed on an original table glass 10. The first carriage 1A is provided with a light source 12. Light is radiated on the original O through the original table glass 10. Reflective light from the original O is led to the 4-line CCD sensor 17 via the first carriage 1A, a second carriage 1B and a converging lens 16.

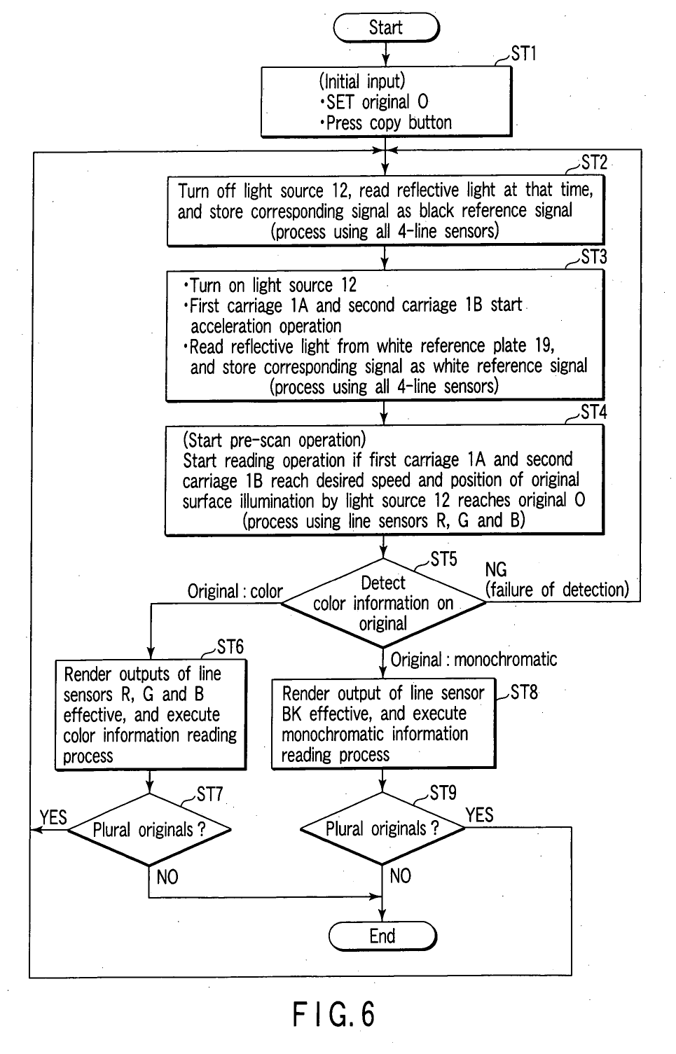

Referring to FIG. 4, FIG. 5 and a flow chart of FIG. 6, a description is given of the carriage operation in the present invention having the above-described structure.

When reading by the image input apparatus 1 is to be started, the first carriage 1A rests at a position outside the effective region for image reading, and the original O is placed on the original table glass 10. If a reading start button (not shown) on the control panel 6 is pressed (ST1), the light source 12 is turned off, image information at that time is stored in the multiple-line memory 2 and a mean value of the image information is set to be a black reference signal (ST2). This state corresponds to a state in which there is no reflective light from the original O.

Subsequently, the light source 12 is turned on, and the first carriage 1A begins to move from the rest state with a gradually acceleration. Image information from a white reference plate (not shown) during the acceleration or during desired uniform motion after the end of acceleration is stored in the multiple-line memory 2, and a mean value of the image information is set to be a white reference signal (ST3). Like the black reference signal, the information obtained from multiple-line reading is averaged. The reason for this is that if a stain or dust, for instance, lies on the white reference plate 19, information relating to a pixel at such an irregular location may be missing. In order to eliminate the effect of such an irregular location, multiple-line reading is performed.

If the first carriage 1A is moved to the distal end of the original, reflective light from the original O is read by the line sensors R, G and B of the 4-line CCD sensor 17. The reading operation, as illustrated in FIG. 4 and FIG. 5, is “pre-scan”, and it is determined whether the original O is a color original or a monochromatic original (ST5).

If the result of the pre-scan shows that the original O is a color original, the first carriage 1A is returned to the position of the front end of the original, and the operation for reading image information on the original O is executed by using the line sensors R, G and B of the 4-line CCD sensor 17 (ST6, 7).

If it is determined that the original O is a monochromatic original, the operation for reading image information on the original O is executed by using the line sensor BK of the 4-line CCD sensor 17 (ST8, 9).

In the case where outputs from the 4-line CCD sensor 17 are parallel-processed, the processing circuits of the line sensors R, G and B are rendered effective when the color original is read, and the processing circuit of the line sensor BK is rendered effective when the monochromatic original is read.

If such a configuration is adopted that an output from one of the line sensor BK and line sensors R, G and B is switchable by a switch, the switching by the switch is executed. For example, at the time of reading a monochromatic original, only the output from the line sensor BK is rendered effective by a COLOR/MONO switch signal. At the time of reading a color original, the output from the line sensor B is rendered effective by a COLOR/MONO switch signal and the outputs from the line sensors R, G and B are parallel-processed.

In this example, the output from the line sensor B and the output from the line sensor BK are switched. Alternatively, the line sensor R or line sensor G, and the line sensor BK may be switched.

In a case of a 2-system output type line sensor BK in which an output from an odd-numbered pixel of the line sensor BK and an output from an even-numbered pixel of the line sensor BK are separately produced in two systems, a similar process can be executed by switching the outputs from the line sensor BK and outputs from two of the three line sensors R, G and B.

Next, a specific method of detecting color information on the original O in the pre-scan is explained.

The line sensors R, G and B have different color filter characteristics. Thus, the ratio between output signals varies depending on the color information on the original.

Some examples are shown below.

In a case where color information of an original is white: line sensor R output=FFH, line sensor G output=FFH, and line sensor B output=FFH.

(In fact, in fear of saturation of the signal, such a setting is adopted as to prevent the signal amplitude from increasing up to FFH; however, for the purpose of explanation, “FFH” is described. Similarly, for the purpose of explanation, “FFH” is used in connection with other color information.)

In a case where color information of an original is gray: line sensor R output=80H, line sensor G output=80H, and line sensor B output=80H.

In a case where color information of an original is black: line sensor R output=00H, line sensor G output=00H, and line sensor B output=00H.

In a case where color information of an original is red: line sensor R output=FFH, line sensor G output=00H, and line sensor B output=00H.

In a case where color information of an original is green: line sensor R output=00H, line sensor G output=FFH, and line sensor B output=00H.

In a case where color information of an original is blue: line sensor R output=00H, line sensor G output=00H, and line sensor B output=FFH.

In a case where color information of an original is yellow: line sensor R output=FFH, line sensor G output=FFH, and line sensor B output=00H.

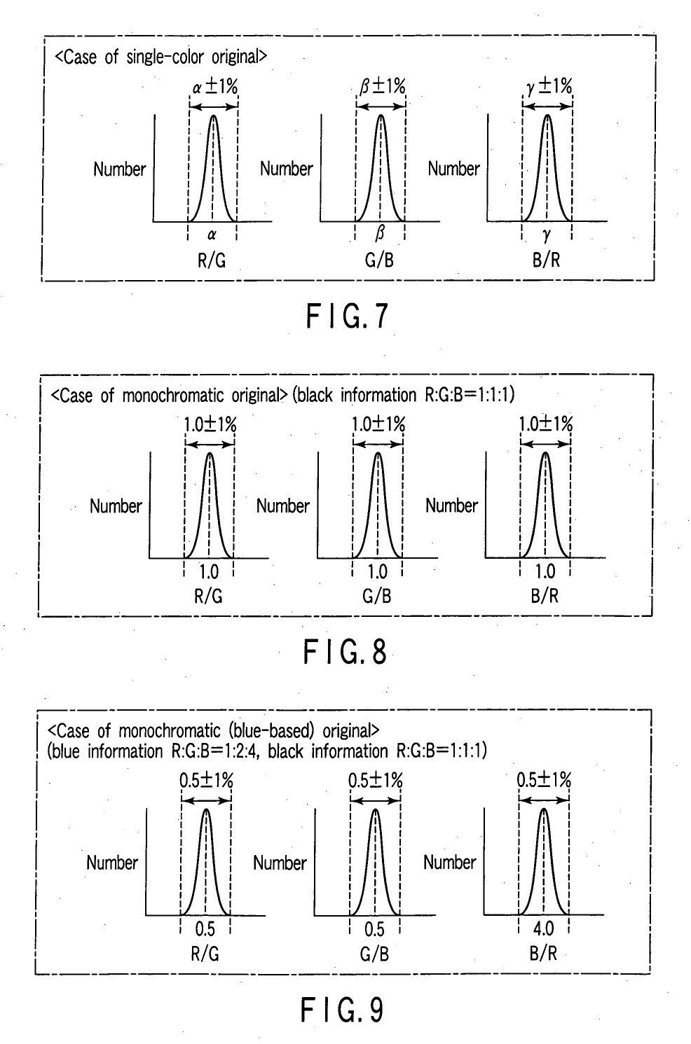

FIGS. 7, 8 and 9 illustrate concepts of color information detection on originals.

Referring to the above-described information relating to the color information of the original that is white/gray/black, the outputs from the respective line sensors are different and are FFH, 80H and 00H, but the ratio is “1” in all cases (α=1, β=1, γ=1 in FIG. 7). However, it is difficult that the ratio perfectly becomes “1” because of variance in sensitivity of line sensors and variance in spectral characteristics of the light source. It is necessary, therefore, to tolerate a certain degree of variance of, e.g. 1±1%.

In the case of the monochromatic original, for example, if R:G:B=1:1:1, R/G=1.0, G/B=1.0, and B/R=1.0.

In the case where the color information on the original is only blue-based information, for example, if R:G:B=1:2:4, R/G=0.5, G/B=0.5, and B/R=4.0. If this ratio is maintained in consideration of a tolerance error, it can be determined that the color information on the original is composed of a blue-based single color.

Next, referring to FIGS. 10, 11 and 12, a description is given of the detection in the case where the color of the background on the original O is not white and image information is present on the background.

In this case, two constant values relating to the color information on the original are detected: R/G=0.5 and R/G=1.0 in FIG. 10; G/B=0.5 and G/B=1.0 in FIG. 11; and B/R=4.0 and B/R=1.0 in FIG. 12. If the number relating to the former ratio greatly exceeds the number relating to the latter ratio, it is discriminated that the former ratio is background color information and the latter ratio is image information. As a result, it can be determined that the original is a single-color original having black image information lying on a blue background.

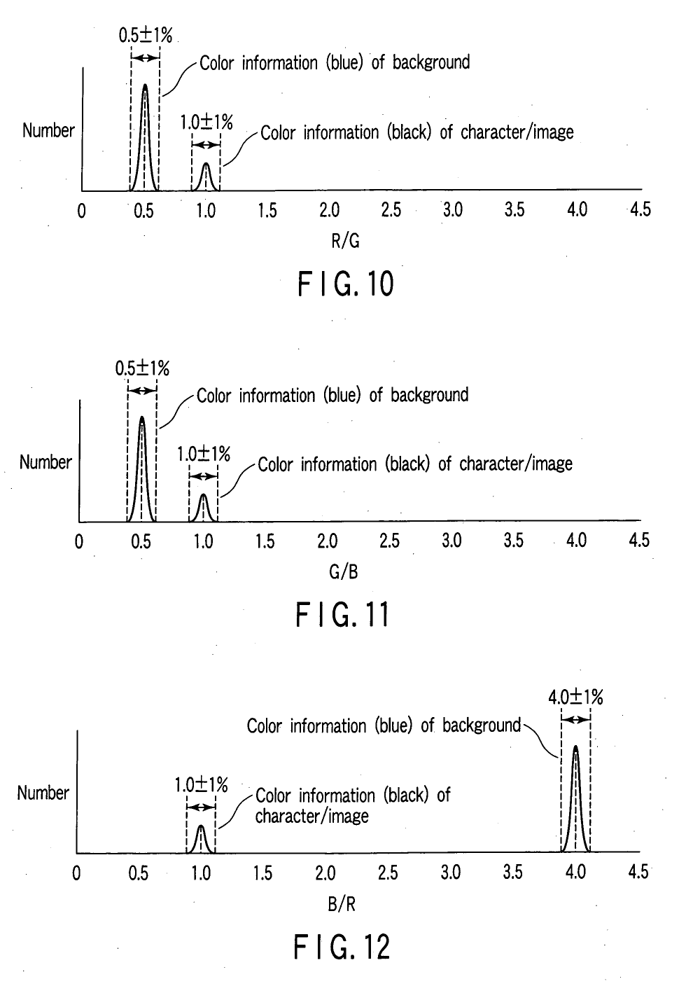

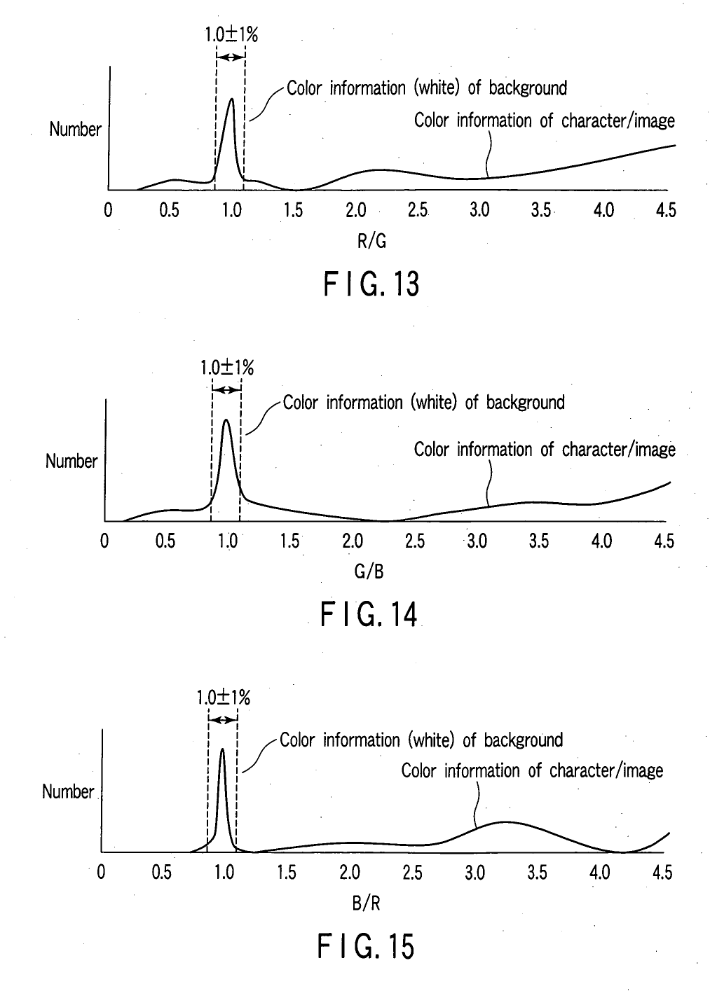

FIGS. 13, 14 and 15 show cases of color originals. As is shown in FIGS. 13, 14 and 15, there are unique masses relating to ratios of R/G, G/B and B/R of the background color information. On the other hand, there are irregularities relating to other image information, and color information has no fixed ratios. As a result, it is determined that the original O is a color original that is composed of a plurality of colors.

Next, another embodiment will be described.

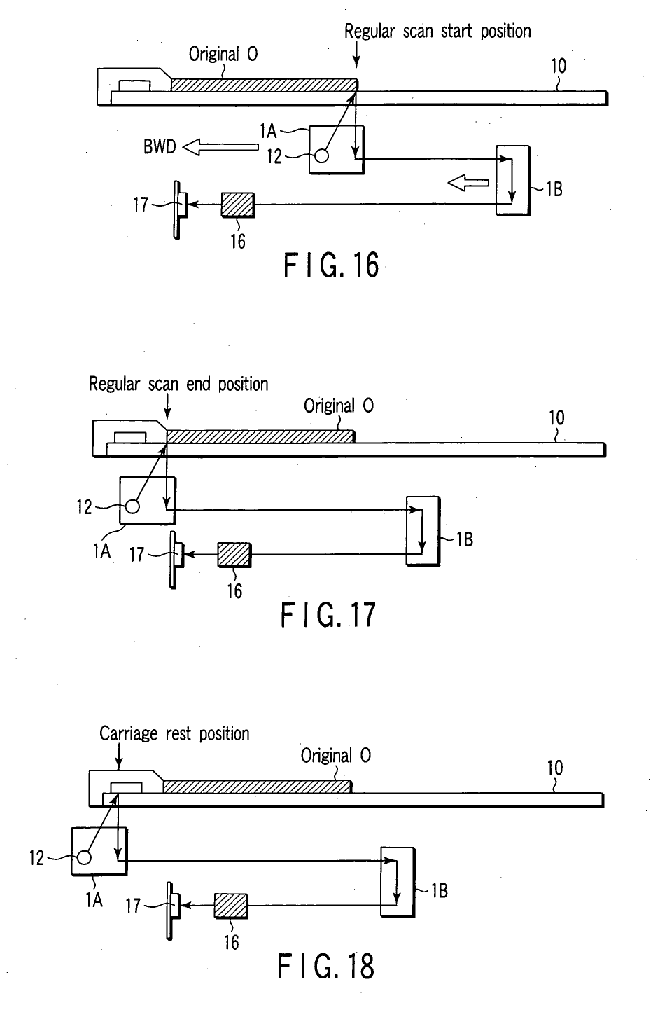

FIGS. 16, 17 and 18 illustrate a scan operation of an original scan section using the 4-line CCD sensor 17 in the image input apparatus 1.

In the prior art, in a pre-scan that is executed to detect color information on the original O, the first carriage 1A and second carriage 1B are once reciprocally moved. Each carriage is returned to the front end of the original or to a reference position of the carriage. Then, regular scan is executed.

In the present embodiment, pre-scan is executed by moving each carriage in a forward (FWD) direction. As is shown in FIG. 16 and FIG. 17, regular scan is executed, without returning the carriage to the initial position, at a timing when the carriage is moved in a backward (BWD) direction from the pre-scan end position. Specifically, the regular scan is executed backward from a regular scan start position shown in FIG. 16 to a regular scan end position shown in FIG. 17.

Thus, as shown in FIG. 18, the first carriage 1A returns to the carriage rest position.

By performing this operational process, the pre-scan and regular scan can be executed only by the single reciprocal movement of each carriage.

During the time period from the end of the pre-scan to the switching of the carriage movement direction from FWD to BWD, the switching process for the line sensor (BK, or R, G, B) is executed based on the above-described detection result of color information on the original O.

If the above-described operational process is executed, the order of output of image information becomes different from that in the prior art.

The order of output of image information differs between the case of the prior art in which regular scan is executed in the FWD direction, and the case of the present invention in which regular scan is executed in the BWD direction. Specifically, if regular scan is executed in the BWD direction, the pixel transfer direction (main scan direction) is a regular order but the carriage movement direction (sub-scan direction) is reversed, and hence a mirror image is obtained. When the mirror image is to be corrected to a regular image, mirror-image signals are stored in the memory 2 that stores all read image signals, and the image signals are successively read out of the memory 2 from the image signal of the last line. Thereby, image information that is composed in the order of regular image information can be obtained.

Next, another embodiment is described.

In this embodiment, when pre-scan for detecting only color information on the original O is executed, there is no need to execute the pre-scan with a resolution for regular scan. Thus, the movement speed of the first carriage 1A and second carriage 1B is increased. As a result, the resolution in the sub-scan direction decreases, but the time for single reciprocal movement of the carriage can be reduced.

For example, the carriage movement speed at the time of pre-scan is set to be twice as high as the carriage movement speed at the time of regular scan. In this case, the resolution for reading in the sub-scan direction becomes 300 dpi that is half the resolution of 600 dpi for regular scan (in the case where the resolution for regular scan is 400 dpi, if the speed of the carriage is doubled, the resolution becomes 200 dpi).

A further increase in speed can be achieved if the speed at the pre-scan is increased up to more than double the speed for regular scan.

The carriage movement direction at the time of pre-scan may be either the FWD direction or BWD direction. Compared to the information of the original image, the read image obviously degrades due to the decrease in resolution. However, since the object of the pre-scan is to detect the color information on the original O, no problem will arise.

Still another embodiment will be described.

FIGS. 19 to 25 illustrate the scan operation of the original scan section using the 4-line CCD sensor 17 in the image input apparatus 1.

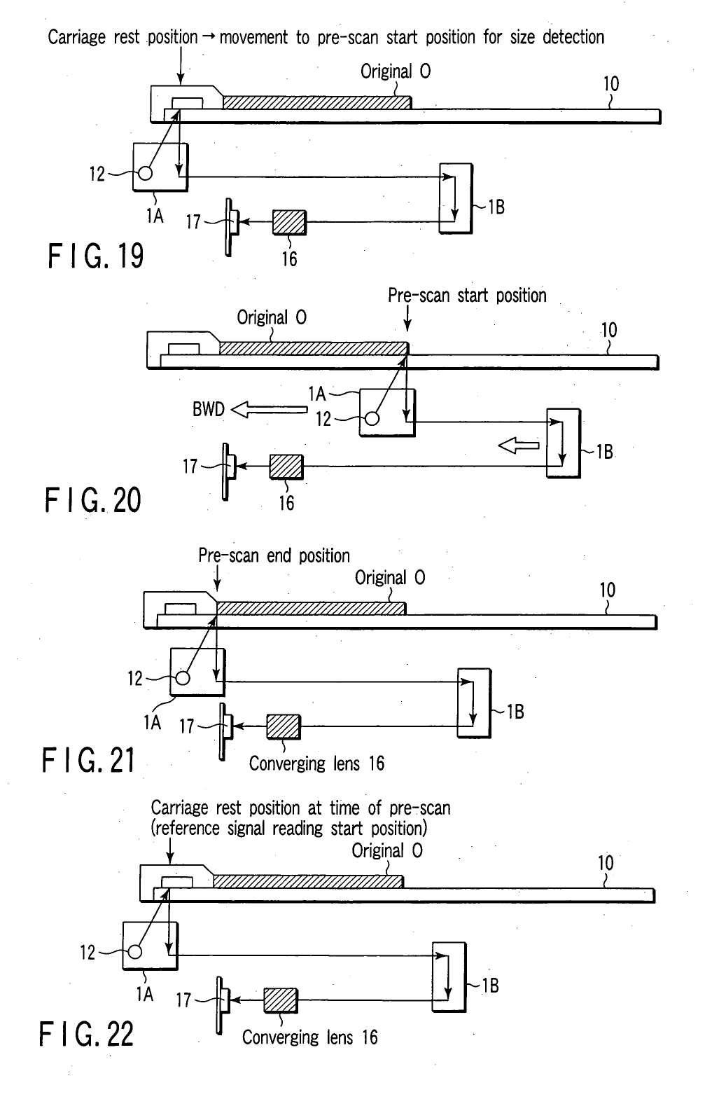

To start with, in this embodiment, as shown in FIG. 19, the first carriage 1A is moved from the carriage rest position to the rear end of the original O. Then, as shown in FIG. 20, the first carriage 1A is moved in the BWD direction from the rear end of the original O, and pre-scan is executed. After the pre-scan is executed up to the front end of the original, as shown in FIG. 21, the first carriage 1A is moved to the carriage rest position for the pre-scan time, as shown in FIG. 22.

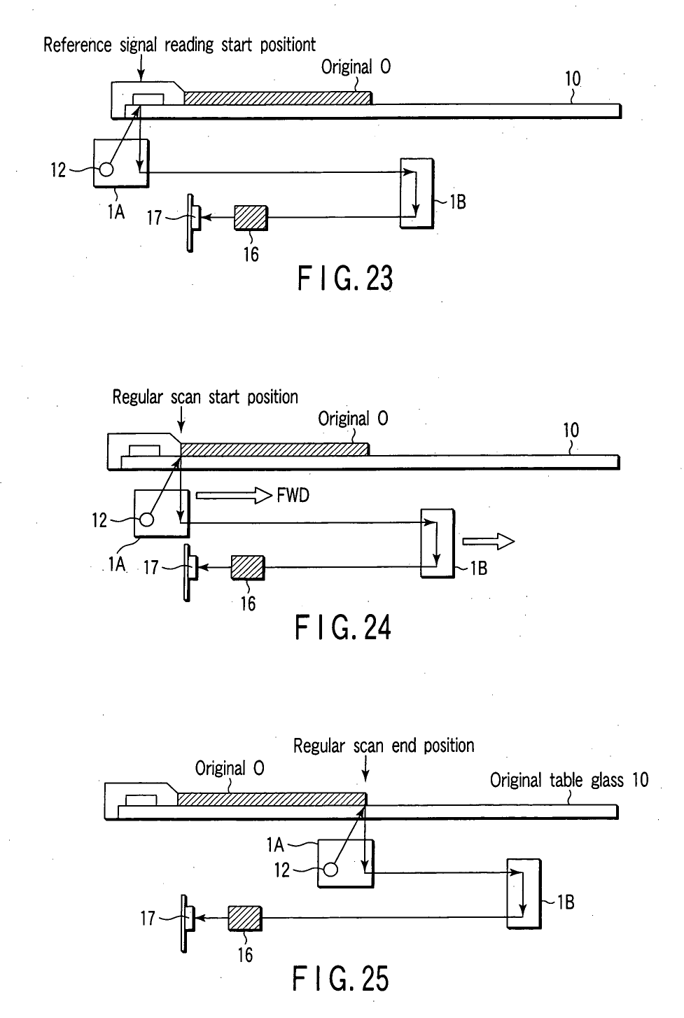

Subsequently, as shown in FIG. 23, regular scan is started from the reference signal reading start position of the first carriage 1A. As is shown in FIG. 24, each carriage is moved in the FWD direction, and the regular scan is executed up to the regular scan end position, as shown in FIG. 25.

If this operational process is executed, the read image information becomes mirror-image information at the time of the pre-scan that detects only the color information on the original O. However, at the time of the regular scan, the information on the original O can be reproduced.

Next, another embodiment is described.

In this embodiment, when the pre-scan for detecting the color information on the original O is executed and it is determined that the original O is a single-color original that is not monochromatic, the color information that is obtained by the pre-scan is stored. Like the reading of a monochromatic originals the original O is read by using only the line sensor BK, and thereby the reading speed is increased. In this case, when image information is to be output, it is necessary to add the color information, which is obtained by the pre-scan, to the read image information. An example is shown below.

Image information obtained by regular scan: (background) gray, (other image formation) black.

Image information obtained by pre-scan: (background) blue, (other image information) navy blue.

Based on the above image information, the gray information of the image information obtained by the regular scan is converted to blue information, the black information of the image information obtained by the regular scan is converted to navy blue information, and the color information is added to the image information obtained by the regular scan.

The above description has been directed to the image input apparatus 1 using the 4-line CCD sensor 17. By connecting the image input apparatus 1 to the image forming apparatus 4, as shown in FIG. 1, the copying apparatus 8 can be constructed.

The image forming apparatus 4 comprises the laser optical system 41 and image forming unit 42. The image forming unit 42 may be of a type that includes photoconductor bodies corresponding to four different colors, or of a type that includes one photoconductor body on which an image is formed by rotating a developing unit four times. These types are conventional ones, so a detailed description is omitted.

In the image input apparatus 1 using the 4-line CCD sensor 17, a monochromatic image can be formed with high efficiency by controlling the image forming unit 42 of the image forming apparatus 4 on the basis of the detection result of the pre-scan that detects the color information on the original O.

As is shown in FIG. 1, the image forming apparatus 4 may be connected to the network 9 via the system control unit 5 so that the image forming apparatus 4 can be used as a network printer that enables output of image information from the external computer (PC1, PC2, PC3).

In addition, as is shown in FIG. 1, the image input apparatus 1 may be connected to the network 9 via the system control unit 5 so that image information, which is read by the image input apparatus 1, can be output to the external computer (PC1, PC2, PC3).

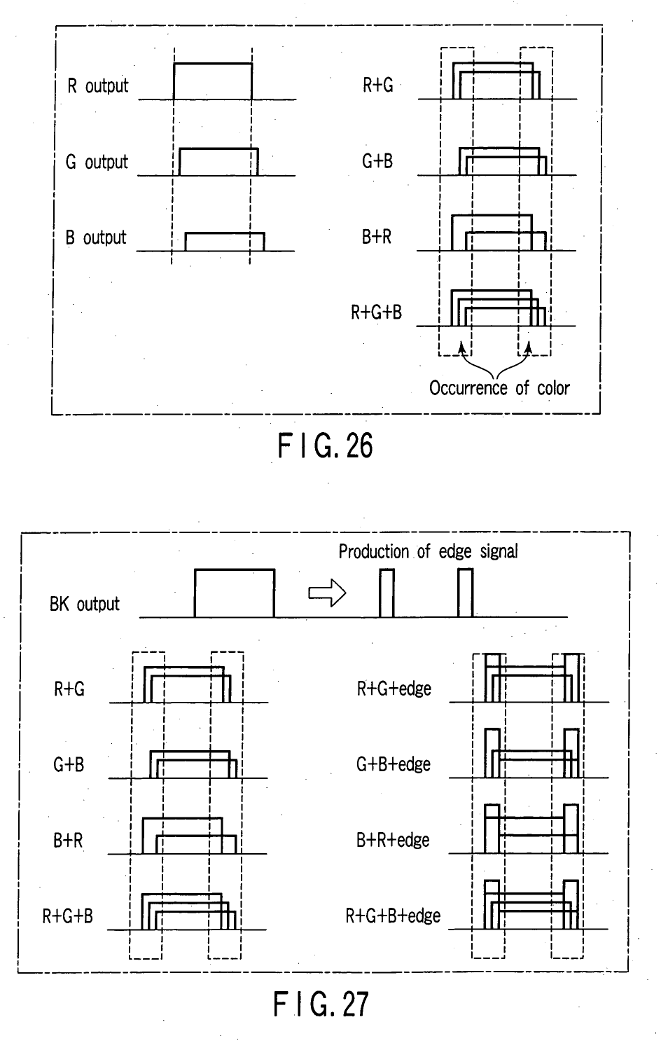

Next, still another embodiment is described with reference to FIG. 26 and FIG. 27.

In this embodiment, color information on the original O is detected by executing pre-scan using the line sensors R, G and B having light receiving surfaces on which color filters are disposed. In the case where the original O is a monochromatic original, the original is read by the line sensor BK on which no color filter is disposed. When it is determined that the original O is a color original, the reading operation is executed using the line sensor BK in addition to the line sensors R, G and B.

Since the line sensors R, G and B are disposed at physically different positions, a misregistration may occur, as illustrated in FIG. 26, if read images are compounded.

In FIGS. 26 and 27, the amplitudes of output signals from the respective line sensors are indicated as being different, for the purpose of description.

The output from the line sensor BK represents a detection result of density, regardless of the color of the original. Thus, on the basis of the output from the line sensor BK, parts at which image color information changes, as shown in FIG. 27, can be calculated as an edge signal. By adding the edge signal to the color misregistration signal shown in FIG. 26, a misregistration component at a time of color overlay can easily be corrected.

As has been described above, according to the present embodiment, in the image input apparatus using the 4-line CCD sensor, color information on the original is detected in advance by executing pre-scan. If the detection result shows that the original is a color original, the original is read by the three line sensors, on the light receiving surfaces of which the R, G and B color filters are disposed. If the detection result shows that the original is a monochromatic original, the original is read by the single line sensor, on the light receiving surface of which no color filter is disposed.

In the prior art, there is the phenomenon that a pseudo-color occurs at a part where white information changes to black information or at a part where black information changes to white information, due to the difference in physical position of the line sensors of the 3-line CCD sensor, when the monochromatic original is read by the color scanner using the 3-line CCD sensor, on the light receiving surfaces of which the R, G and B color filters are disposed. However, in this embodiment, such a coloring phenomenon can be prevented by the use of the 4-line CCD sensor.

In addition, in the prior art, the pre-scan is executed as an independent operation. However, in this embodiment, both the pre-scan and regular scan can be executed in a series of reciprocal motions. Thus, even if the pre-scan is executed, the number of scanned documents per unit time does not decrease.

Besides, the line sensor with no color filter is used for detecting a variation in density of image information. Thereby, color misregistration can easily be corrected, and occurrence of pseudo-coloring at edge parts can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image input apparatus that inputs an image of an original using 4-line image sensors, comprising:
a control unit that executes, prior to inputting the image of the original, a control to detect color information of the original using 3-line image sensors, which are included in the 4-line image sensors and have light receiving surfaces provided with color filters;
a determination unit that determines whether the original is a monochromatic original or a color original, on the basis of the color information detected by the control of the control unit;
a first image input unit that inputs, when the determination unit determines that the original is the monochromatic original, the image of the original using a 1-line image sensor, which is included in the 4-line image sensors and has a light receiving surface provided with no color filter; and
a second image input unit that inputs, when the determination unit determines that the original is the color original, the image of the original using the 3-line image sensors, which are included in the 4-line image sensors and have the light receiving surfaces provided with the color filters.

2. The image input apparatus according to claim 1, wherein the control unit controls pre-scan.

3. The image input apparatus according to claim 1, wherein the first image input unit and the second image input unit execute regular image input.

4. The image input apparatus according to claim 1, wherein the image input apparatus includes a carriage comprising a light source that illuminates the original and a mirror that reflects reflective light from the original in a desired direction, and the control unit detects the color information by moving the carriage in a conventional forward direction, following which one of the first image input unit and the second image input unit moves the carriage in a conventional backward direction, thereby inputting the image of the original.

5. The image input apparatus according to claim 1, wherein the image input apparatus includes a carriage comprising a light source that illuminates the original and a mirror that reflects reflective light from the original in a desired direction, and the control unit controls the carriage at a higher movement speed than a speed for regular image input, thereby detecting the color information.

6. The image input apparatus according to claim 1, wherein the image input apparatus includes a carriage comprising a light source that illuminates the original and a mirror that reflects reflective light from the original in a desired direction, and the control unit controls the carriage at a movement speed twice as high as a speed for regular image input, thereby detecting the color information.

7. The image input apparatus according to claim 1, wherein the control unit detects the color information with a resolution that is lower than a resolution of the image that is input by the first image input unit and the second image input unit.

8. The image input apparatus according to claim 1, wherein the image input apparatus includes a carriage comprising a light source that illuminates the original and a mirror that reflects reflective light from the original in a desired direction, and the control unit causes the carriage to rest at a position outside an image input region in an initial state, detects a size of the original at a time of first pre-scan in which the carriage is moved in a conventional forward direction at a start of an original input operation, and then detects the color information of the original at a time of second pre-scan in which the carriage is moved in a backward direction.

9. The image input apparatus according to claim 1, further comprising a third image input unit that stores, when the determination unit determines that the original is a single-color original that is not a monochromatic original, the color information in a memory unit, and inputs the image of the original using a 1-line image sensor, which is included in the 4-line image sensors and has a light receiving surface provided with no color filter.

10. The image input apparatus according to claim 1, wherein the second image input unit inputs a color image of the original using 3-line image sensors, which are included in the 4-line image sensors and have light receiving surfaces provided with color filters, and at the same time inputs density information of the original using a 1-line image sensor that has a light receiving surface provided with no color filter, and compounds color image information of the original by using the input density information of the original as a correction signal for the input color image of the original.

11. An image input apparatus that inputs an image of an original using 4-line image sensors, comprising:
a control unit that detects, prior to inputting the image of the original, color information of the original using 3-line image sensors, which are included in the 4-line image sensors and have light receiving surfaces provided with color filters;
determines whether the original is a monochromatic original or a color original, on the basis of the detected color information;
inputs, when it is determined that the original is the monochromatic original, the image of the original using a 1-line image sensor, which is included in the 4-line image sensors and has a light receiving surface provided with no color filter; and
inputs, when it is determined that the original is the color original, the image of the original using the 3-line image sensors, which are included in the 4-line image sensors and have the light receiving surfaces provided with the color filters.

12. An image forming apparatus including an image input apparatus that inputs an image of an original using 4-line image sensors, the image forming apparatus comprising:
a control unit that detects, prior to inputting the image of the original, color information of the original using 3-line image sensors, which are included in the 4-line image sensors and have light receiving surfaces provided with color filters;
determines whether the original is a monochromatic original or a color original, on the basis of the detected color information;
inputs, when it is determined that the original is the monochromatic original, the image of the original using a 1-line image sensor, which is included in the 4-line image sensors and has a light receiving surface provided with no color filter;
inputs, when it is determined that the original is the color original, the image of the original using the 3-line image sensors, which are included in the 4-line image sensors and have the light receiving surfaces provided with the color filters; and
an image forming unit that forms an image on the basis of image information of the original that is input by the control of the control unit.

13. The image forming apparatus according to claim 12, wherein the control unit detects the color information of the original by pre-scan, and then executes regular image input for the original.

14. The image forming apparatus according to claim 12, wherein the image input apparatus includes a carriage comprising a light source that illuminates the original and a mirror that reflects reflective light from the original in a desired direction, and the control unit detects the color information by moving the carriage in a conventional forward direction, following which the control unit moves the carriage in a conventional backward direction, thereby inputting the image of the original.

15. The image forming apparatus according to claim 12, wherein the image input apparatus includes a carriage comprising a light source that illuminates the original and a mirror that reflects reflective light from the original in a desired direction, and the control unit controls the carriage at a higher movement speed than a speed for regular image input, thereby detecting the color information.

16. The image forming apparatus according to claim 12, wherein the image input apparatus includes a carriage comprising a light source that illuminates the original and a mirror that reflects reflective light from the original in a desired direction, and the control unit controls the carriage at a movement speed twice as high as a speed for regular image input, thereby detecting the color information.

17. The image forming apparatus according to claim 12, wherein the control unit detects the color information with a resolution that is lower than a resolution for regular image input.

18. The image forming apparatus according to claim 12, wherein the image input apparatus includes a carriage comprising a light source that illuminates the original and a mirror that reflects reflective light from the original in a desired direction, and the control unit causes the carriage to rest at a position outside an image input region in an initial state, detects a size of the original at a time of first pre-scan in which the carriage is moved in a conventional forward direction at a start of an original input operation, and then detects the color information of the original at a time of second pre-scan in which the carriage is moved in a backward direction.

19. The image forming apparatus according to claim 12, wherein the control unit stores, when the determination unit determines that the original is a single-color original that is not a monochromatic original, the color information in a memory unit, and inputs the image of the original using a 1-line image sensor, which is included in the 4-line image sensors and has a light receiving surface provided with no color filter.

20. The image forming apparatus according to claim 12, wherein the control unit inputs a color image of the original using 3-line image sensors, which are included in the 4-line image sensors and have light receiving surfaces provided with color filters, and at the same time inputs density information of the original using a 1-line image sensor that has a light receiving surface provided with no color filter, and compounds color image information of the original by using the input density information of the original as a correction signal for the input color image of the original.
